(19) United States
(12) Patent Application Publication
(10) Pub. No.: US 2019/0228397 A1
(43) Pub. Date: Jul. 25, 2019

(54) DYNAMIC ECONOMIZER METHODS AND SYSTEMS FOR IMPROVING PROFITABILITY, SAVINGS, AND LIQUIDITY VIA MODEL TRAINING

(71) Applicant: The Bartley J. Madden Foundation, Naples, FL (US)

(72) Inventor: Bartley J. Madden, Naples, FL (US)

(21) Appl. No.: 15/880,115

(22) Filed: Jan. 25, 2018

(51) Int. Cl. G06Q 20/20; G06Q 20/24; G06Q 20/32; G06Q 30/02; G06F 15/18

(52) U.S. Cl. CPC G06Q 20/204; G06Q 20/24; G06F 15/18; G06Q 30/0238; G06Q 20/3223

(57) ABSTRACT

A method of optimizing future profits may include receiving an order inquiry and/or data of the user at a server device, including one or more product of interest, and training a machine learning model by analyzing labeled data. The method may include analyzing the data of the user and at least one product of interest using the trained machine learning model to generate a discounted price for the product of interest that is lower than the credit card price of the product of interest, and/or a credit limit associated with the user. The discounted price and/or credit limit may be transmitted to a user device, and an economizer selection may be received which circumvents the usage of a credit card, and a withdrawal request and/or deposit request may be initiated in response to the economizer selection.

### TECHNICAL FIELD

The present invention generally relates to systems and methods for improving profitability, savings, and liquidity. More particularly, the present disclosure is directed to methods and systems for improving the profitability of sales, savings to consumers, and the liquidity available to buyers and sellers.

### BACKGROUND

Revolving credit is well-known in the art, and is characterized by credit accounts which have variable, or “revolving”, payment schedules. Credit cards are an example of revolving credit used by consumers, wherein the consumer may repeatedly use and repay the funds up to the account maximum. In general, a credit card is issued to a consumer by a lender, and authorizes the consumer to draw upon funds up to a pre-approved credit limit. As the consumer borrows against the account, the amount of available funds may decrease accordingly. As the consumer makes payments, the amount of funds may increase. The borrower's credit limit may change over time (e.g., in response to the consumer requesting a credit limit increase) and the consumer's credit account may be subject to fees and interest. The credit account may require that minimum payments are made according to a schedule (e.g., monthly), and the minimum payments may be a percentage of the consumer's balance, i.e., the amount of the pre-approved credit that the consumer has used, including applicable interest.

Credit card accounts are issued to consumers by banks, and are typically branded by a credit clearinghouse (e.g., Master Card, Visa, etc.). The credit clearinghouse may perform clearing functions between issuing and acquiring banks, and may also perform account-specific functions such as monitoring consumer credit, setting consumer credit limits, imposing interest rates on unpaid balances, and charging transaction fees to the merchants on purchases made by their customers.

Transaction fees may be paid by merchants to process consumer credit card transactions, and may include interchange fees, and/or fees paid to credit clearinghouses. Interchange fees may be calculated as a percentage of each transaction, in addition to a fixed transaction fee (e.g., 2.2% plus $0.20 for each credit card consumer purchase). Transaction fees may further include assessment fees, network access fees, foreign handling fees, etc. It should be appreciated that fees may be imposed for not only purchase transactions, but also for return and refund transactions. Transaction fees may be assessed differently for credit and debit cards, and may include markup, in addition to interchange and assessment fees. Fees necessary to facilitate additional entities in the transaction pipeline may be paid. The transaction fees imposed by various credit card intermediaries may lack standardization and transparency. Therefore, merchants may be unable to directly compare credit card processing/transaction fees as between multiple card processing intermediaries. Fees may be flat (e.g., monthly), per transaction (e.g., based on API calls), or based on volume, and therefore, comparing them as between intermediaries may not be possible.

Credit card companies' fees may be necessary to counter the risks attendant to issuing revolving consumer credit accounts (e.g., fraud, default, etc.) and to create a profitable network of intermediaries. However, the amount of fees that a given merchant is required to pay to a card processor to enable the merchant to accept credit card payment effectively reduces the merchant's profit by a proportional amount. Therefore, a merchant may accept lower profits, or may raise prices to include the credit card processing fees, and in doing so, will likely reduce sales.

Some merchants have attempted to circumvent the relatively high cost of transaction fees paid to intermediary credit clearinghouses. For example, to compete against the major credit card companies, merchants in the past have issued their own branded credit cards. However, merchant-branded credit cards are of limited value, because a consumer may be required to obtain a merchant-branded credit card for each store the consumer visits. Additionally, some merchants have offered a discount for cash purchases; however, that approach is of limited utility (e.g., does not facilitate digital commerce).

Additionally, existing credit card commerce may be an entirely static process, in that the prices of goods and services, as well as available consumer credit, may be pre-determined at the time of sale and not variable or adjustable by methods and systems according to any criteria at the time of a consumer purchase. Therefore, there is an opportunity for dynamic economizer methods and systems to benefit both merchants and consumers by analyzing variables such as the consumer's purchasing history and financial characteristics, the type(s) of products being sold, available inventory, etc. using machine learning techniques (e.g., by training/operating an artificial neural network) to dynamically determine pricing of the products to be purchased, adjust the consumer's credit limit, etc.

Consequently, there is a need for dynamic economizer methods and systems to facilitate liquidity and transaction processing without using a central counterparty while also lowering prices and improving profitability.

### BRIEF SUMMARY

In one aspect, a method for optimizing future profits includes receiving an order inquiry and data of the user, wherein the order inquiry includes at least one product of interest; training a machine learning model by analyzing labeled data; and analyzing the data of the user and at least one product of interest using the trained machine learning model to generate one or both of (i) a discounted price corresponding to the product of interest, wherein the discounted price is lower than a credit card price corresponding to the product of interest, and (ii) a credit limit associated with the user. The method may further include transmitting the one or both of the discounted price, and the credit limit, receiving an economizer selection wherein the economizer selection circumvents credit card usage, and in response to the economizer selection, one or both of (i) initiating a withdrawal of funds from a first ledger, and (ii) initiating a deposit of funds into a second ledger.

In another aspect a computing system including one or more processors and one or more memories storing instructions is provided. When the instructions are executed by the one or more processors, they cause the computing system receive an order inquiry and data of the user, wherein the order inquiry includes at least one product of interest; train a machine learning model by analyzing labeled data, and analyze the data of the user and at least one product of interest using the trained machine learning model to generate one or both of (i) a discounted price corresponding to the product of interest, wherein the discounted price is lower than a credit card price corresponding to the product of interest, and (ii) a credit limit associated with the user. The instructions may further cause the computing system to transmit the one or both of the discounted price, and the credit limit, receive an economizer selection, wherein the economizer selection circumvents credit card usage, and in response to the economizer selection, one or both of (i) initiate withdrawal of funds from a first ledger, and (ii) initiate deposit of funds into a second ledger.

### BRIEF DESCRIPTION OF THE FIGURES

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 depicts an example environment in which execution, training, and delivery of models to improve profitability and liquidity; according to one embodiment;

FIG. 2 depicts a flow diagram for an economizer processed payment and delivery using models to improve profitability and provide liquidity, according to one embodiment;

FIG. 3A depicts an example artificial neural network for generating economizer data that may be trained by the model training module of FIG. 1, according to an embodiment;

FIG. 3B depicts an example neuron, according to an embodiment, that may be included in the artificial neural network of FIG. 3A, according to one embodiment;

FIG. 4 depicts an example method of using economizer methods to provide liquidity and process payments via training a machine learning model, according to an embodiment;

FIG. 5 depicts an example method for training an economizer machine learning model to maintain liquidity with respect to existing customer accounts, according to an embodiment;

FIG. 6A depicts an exemplary user interface 600 for presenting, processing, and displaying checkout options, according to an embodiment; and

FIG. 6B depicts an exemplary user interface for analyzing, presenting, and displaying an update of a merchant economizer account.

### DETAILED DESCRIPTION

### I. Overview

The embodiments described herein relate to, inter alia, methods and systems for facilitating liquidity transaction processing without using a central counterparty while also lowering prices and improving profitability. More specifically, in some embodiments, machine learning (ML) or other models may be trained which may allow merchants to offer a superior alternative to existing intermediary-based fee-charging systems (e.g., credit cards) while simultaneously lowering prices to customers and improving the profitability of the merchants' stores. The methods and systems described herein may include numerous economic benefits to both consumers and merchants.

For example, merchants may provide an ongoing source of liquidity that consumers may draw upon to make purchases, and the cost to merchants of providing this source of liquidity may be far less than the cost of paying transaction fees to central counterparty banks to process consumer purchases made with a credit card. The cost savings realized by merchants may enable the merchants to lower prices for products purchased by their customers, thereby driving higher sales, while increasing their own profitability. Consumers who are presented with a visual display that reinforces the avoidance of credit card interest and transaction fees may strongly prefer making payment via the economizer methods and systems described herein.

Trained models providing economizer discounts/prices combined with checkout graphical user interfaces (GUIs) may provide customers with an easy-to-understand, visual, and quantitative communication regarding the economic benefits of avoiding credit card usage. Customers are able to execute their personal preferences regarding the capture of immediate savings on the purchase of products which, at times, may require a withdrawal from their bank account to keep their account balance under the credit limit. The methods and systems described herein provide a customer with a practical way to actively participate in the economic tradeoffs involving credit card convenience, high interest payments on credit card balances, higher product prices paid with credit cards due to transaction fees, and lower economizer prices, which occasionally may require the customer to withdraw/deposit funds from/to the customer's bank account.

Further, from perspective of sellers, the use of trained models with graphical user interfaces as described herein provides a physical means for merchants to dynamically analyze (e.g., at the time of consumer purchases) customers' information in customer databases and set prices and/or credit limits to optimize the expected value of future profits from individual customers while providing substantially lower prices to their customers. In this way, high profits historically earned by major credit card companies are instead distributed as higher merchant profits and greater value to customers. In addition, by sending periodic updates to customers, merchants are able to educate customers about the economics which enable the merchants to provide lower prices. The periodic updates, whether via email or another method, may leverage models to explain likely future credit limits tied to future customer purchase and required minimum future purchases necessary to avoid paying down existing balances. The periodic updates incentivize individual consumers to make significant future purchases resulting in mutual benefits to merchants and customers by elimination of credit card usage.

### II. Example Environment for Training, Execution, and Delivery of Models

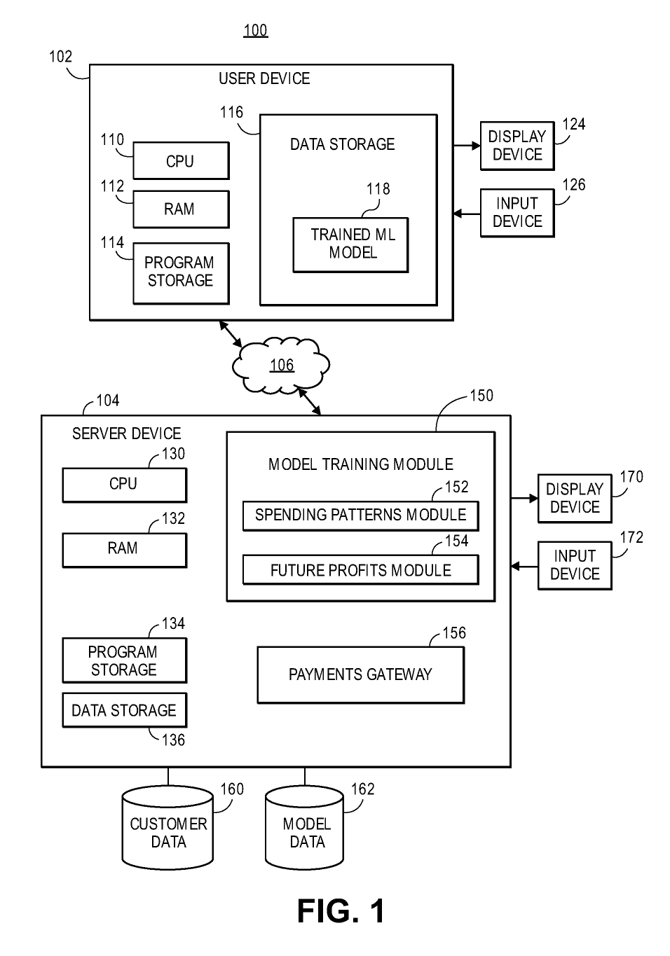

Turning to FIG. 1, an example environment 100 in which execution, training, and delivery of models to improve profitability and liquidity is depicted, according to an embodiment. Environment 100 may include a user device 102 and server device 104.

User device 102 may be any suitable device such as a smartphone, tablet, wearable device, or any other suitable type of personal electronic device. User device 102 may include a CPU 110 and a RAM 112 for executing and storing, respectively, a ML model 118. User device may include a program storage 114 and data storage 116 for storing, respectively, program sources, and models such as ML model 118. User device 102 and server device 104 may be communicatively coupled via network 106. Network 106 may include one or more suitable wireless networks, such as a 3G or 4G network, a WiFi network or other wireless local area network (WLAN), a satellite communication network, and/or a terrestrial microwave network, for example. In some embodiments, network 106 also includes one or more wired networks, such as Ethernet. While referred to in the singular, CPU 110 may include any suitable number of processors of one or more types (e.g., one or more CPUs, graphics processing units (GPUs), cores, etc.). RAM 112 may comprise one or more memories of one or more types (e.g., persistent memory, solid state memory, random access memory, etc.), and may store program storage 114, data storage 116, and/or ML model 118.

Program storage 114 may include compiled ML models, source code, loading code, and other program sources. Data storage 116 may include data used by ML model 118. For example, data storage 116 may include binary data, a database, a flat text file, or any other suitable type of data used for the initialization, operation, and/or adjustment of ML model 118. Any number of ML model 118 may be included in data storage 116, each of which ML model 118 may be associated with a respective set of program instructions/sources stored in program storage 114, and/or a respective set of data stored in data storage 116. Program storage 114 and/or data storage 116 may be integral to RAM 112. Program storage 114 may store data used by ML model 118 during the execution of ML model 118. In some embodiments, “data” may refer to data used to initialize/operate ML model 118, or data analyzed and/or output by trained ML model 118. Data storage 116 may be populated with data loaded from program storage 114 by CPU 110, or via a network such as network 106. In an embodiment, data storage 116 may include an application (e.g., a wrapper, or package) which contains or otherwise includes ML model 118. Such an application may be a mobile application (e.g., an Android APK) and may be provided by server device 104, or another server. The application may contain instructions that, when executed, enable CPU 110 to execute ML model 118. In some embodiments, the application may be available for download and/or purchase from an application store.

ML model 118 may include any suitable model(s), including a machine learning model, an artificial neural network (e.g., a feed-forward neural network), a statistical model (e.g., a Bayesian model), etc. ML model 118 may process input, such as raw input from input device 126. Input may include any suitable machine-readable input, such as integers and strings, or more complex data (e.g., objects in an object-oriented programming language). As discussed above, user device 102 may receive ML model 118 via network 106 from, for example, server device 104. In some embodiments, ML model 118 may be trained by CPU 110 executing instructions in program storage 114, without accessing network 106.

User device 102 may also include display device 124 and input device 126. Display device 124 may be either integral or external to user device 102, and may use any suitable display technology (e.g., LED, OLED, LCD, etc.). Input device(s) 126 may include components that are integral to user device 102, and/or exterior components that are communicatively coupled to user device 102, to enable user device 102 to read/retrieve inputs from the user via input device 126. For example, input device(s) 126 may include a mouse, a keyboard, a trackball device, a microphone, scanner, etc. In some embodiments, display device 124 and input device(s) 126 are integrated, such as in a touchscreen display. Generally, display device 124 and input device(s) 126 combine to enable a user to interact with user interfaces provided by user device 102, for example, user interfaces included in, or provided by, an application stored in program storage 114 and/or data storage 116.

Server device 104 may include a CPU 130 and a RAM 132 for executing and storing, respectively, a model training module 150. Server device 104 may comprise one or more server computers which may be controlled by one or more respective entities. While referred to in the singular, CPU 130 may include any suitable number of processors of one or more types (e.g., one or more CPUs, graphics processing units (GPUs), cores, etc.). RAM 132 may comprise one or more memories of one or more types (e.g., persistent memory, solid state memory, random access memory, etc.). Server device 104 may include program storage 134 and data storage 136 for storing, respectively, program sources, and program data. Program storage 134 may include instructions which, when executed by CPU 130, cause model training module 150 to create and train new models or to perform other operations. Training of models may be based on the instructions and input (e.g., input received from user device 102). Data storage 136 may include ML models trained by model training module 150, as well as input to, and output from, those trained models. Data storage 136 may receive data from databases and may write data to databases. In an embodiment, models “learn” by model training module 150 training the models using historical data to assist in calibrating economizer variables (e.g., credit limits, products prices, etc.) for individual transactions dynamically (e.g., in real time with respect to an entire transaction or a portion thereof) in order to optimize the future profits of the merchant with respect to the consumer. Control variables may include the discounted price of products being purchased/sold and the current credit limit of a consumer. Control variables, like other variables, may vary in real time. In an embodiment, the discounted price of products purchased/sold may vary in real time with respect to each transaction, and the current credit limit of a consumer may vary occasionally; for example, to facilitate payment by a “good” customer (e.g., a customer with a low bank balance and a current economizer account balance close to the economizer credit limit.

Variables may be determined by trained ML model 118 or a model stored in program storage 134, and variables may be stored in model data 162, in association with customer data 160, or product data (e.g., pricing variables may be linked to available product inventory).

Model training module 150 may further include spending patterns module 152, in some embodiments. Spending patterns module 152 may be a machine learning or other model configured to quantify past spending, such as over a time interval (e.g., three months) with respect to one or more consumers. For example, spending patterns module 152 may be an artificial neural network trained to quantify average purchases, and to predict future purchases based on the past spending of a pool of similar consumers. Such a neural network may be trained using labeled data; i.e., data in which information pertaining to a group of users is explicitly linked to a respective set of purchases made by the group of users. The trained neural network may then receive an unrelated consumer's past spending history, and based on analyzing the consumer's purchases of bread and other items, determine that the consumer will purchase, for example, three loaves of bread in the following month. Alternatively, spending patterns module 152 may generate a model detect spending patterns, or trends, among a cohort of consumers. Such a model may be used to predict the likely expenditures of another consumer, absent any information about the consumer. For example, spending patterns module 152 may determine that consumer spending habits have increased 10% month-over-month from October to November with respect to all shoppers at a given grocery. Spending patterns module 152 may then predict that the purchases made by any consumer frequenting the same grocery will be 10% higher as of November 1. It should be appreciated that the foregoing are intended to be simple examples, for illustrative purposes, and that more complex spending pattern models are envisioned. Modules other than spending patterns module 152 may be used, in some embodiments.

Model training module 150 may include future profits module 154, in some embodiments. Future profits module 154 may be a machine learning or other model configured to quantify or predict future profits. For example, future profits module 154 may be an artificial neural network trained using a single consumer's purchases as labeled data. Future profits module 154 may analyze a single type/segment of purchasing (e.g., only produce department items) or all items purchased by the consumer to train a model. Based on the training, the model may predict the amount the consumer will spend in the future, less the predicted cost of goods, to determine a future profit. The predicted cost of goods may be determined by a separate model and may require no information pertaining to the consumer. In some embodiments, the amount the consumer will spend may be determined by an artificial neural network trained on labeled data of other consumers. Future profits module 154 may enforce a minimum acceptable profit, and may be based on a customer's existing account balance, as discussed below. Spending patterns module 152 and future profits module 154 may be used to produce an individual or hybrid trained ML model. The trained ML model may be transferred to user device 102 via network 106, and may ultimately correspond to ML model 118 in user device 102. The trained ML models may be used to provide economizer data in an economizer process.

Server device 104 may also include a payments gateway 156. Payments gateway 156 may be an application programming interface (API) endpoint by which credit card and other payments are processed, according to an embodiment. In an embodiment, payments gateway 156 may be provided by a third party service.

Modules in model training module 150 (e.g., spending patterns module 152 and future profits module 154) may utilize customer data 160, which may be an electronic database or other suitable repository of information describing customers (e.g., demographic information linked to spending information). In some embodiments, a purchase may be linked to a user by an email, credit card, authenticated web session, or other means. The user's information may be retrieved from customer data 160 in real-time at the point of sale, or in advance. Model training module 150 and its sub-modules may also use model data 162, which may be an electronic database storing trained models, as well as data used to train and operate such models, and data produced during the operation of such models. In an embodiment, instructions in program storage 134, when executed by CPU 130, may select one or more models (e.g., a trained artificial neural network) from model data 162 based on any suitable selection criteria (e.g., a customer identity, a product type, etc.).

Server device 104 may include display device 170 and input device 172. Display device 170 may be either integral or external to server device 104, and may use any suitable display technology (e.g., LED, OLED, LCD, etc.). Input device(s) 172 may include components that are integral to server device 104, and/or exterior components that are communicatively coupled to server device 104, to enable server device 104 to read/retrieve inputs from a user (e.g., a server operator) via input device 172. For example, input device(s) 172 may include a mouse, a keyboard, a trackball device, a microphone, scanner, etc. In some embodiments, display device 170 and input device(s) 172 are integrated, such as in a touchscreen display.

In operation, a user may open or utilize an application in user device 102 (e.g., an application executing in RAM 112). In an embodiment, utilizing the application may include accessing a web page served by a web server executing in a server such as server device 104. The user device 102 may be a mobile computing device owned by the user (e.g., a smartphone, tablet, wearable device, etc.) or a device owned/operated by a merchant (e.g., a computing device associated with a point of sale station such as a physical store checkout and cashiering system). Whether the user is utilizing the application in a physical store or an online store, user may interact with the application via display device 124 and input device 126. Server device 104 or the application may contain instructions which when executed, cause the application to authenticate the user. For example, the server may transmit a login form to a web browser or other application executing in the user device 102 to collect the user's credentials, and may include a means for collection (e.g., by reading a key card, credit card, or other authenticating physical token) and submission (e.g., a submit button). Once submitted, the server may check the user's authentication information for validity and if valid, may authenticate the user (e.g., by a session, encrypted cookie, etc.). Once authenticated, a user may be logged-in to one or more merchant sites and may be able to search, view, and select products for purchase. In one embodiment, the user may have already selected items to purchase (e.g., by placing the items in a physical shopping cart). The user may add products, via the application, to a virtual cart, and once satisfied with the contents of the cart, may submit an order inquiry. The order inquiry may be processed in the server by a web server or other end point which may parse the order inquiry and may pass the order inquiry to one or more pre-trained models. For example, the user's identity (e.g., via a session) may be transmitted to a creditworthiness model, where it may be analyzed and a value returned. At the same time, or later, a list of products included in the order inquiry may be transmitted to a trained machine learning model for the determination of economizer data.

In some embodiments, as the consumer views products of interest in the application, prices relating to the products of interest may be dynamically updated. For example, the application may submit one or more request for dynamic pricing to server 104. Server 104 may dynamically determine economizer prices to incentivize the consumer who has not yet made a purchase decision using a trained machine learning model, wherein information pertaining to the user and/or products of interest are used as input to the model. In an embodiment, an increase in economizer credit limit may be an output of the trained machine learning model, and may be presented to the user by the application contingent upon the user making a purchase, wherein the increase is associated to the purchase. Dynamic pricing and likely future profits from the consumer may be determined via analyzing customer data 160 (e.g., consumer characteristics and spending patterns) using a trained machine learning model. The machine learning model may be trained to take into account multiple variables, such as the customer's creditworthiness, frequency of shopping in a store (physical or virtual), and bank balance. For example, if a consumer has a good credit score, buys at the store more than once per month, and has a low bank balance, then the trained neural network model may instantaneously increase the credit limit available to the consumer to avoid further depletion of the consumer's bank account balance. In an embodiment, the dynamic pricing of goods may take into account the commission available to merchant from upstream providers of goods (e.g., wholesalers). A machine learning model may be trained which accepts as input a first product identifier and a second product identifier, and which outputs, based on the respective product identifiers, respective pricing, wherein the respective pricing associated with the first product identifier is more greatly discounted vis-à-vis the second product identifier, because the manufacturer of the product associated with the first product identifier offers a higher commission than the manufacturer of the product associated with the second product identifier. Such a model may be trained continuously, or “online”, to account for rapidly changing wholesaler pricing. As discussed below, the economizer data may be used to create graphical user interface screens that may be presented to the user. In some embodiments, multiple models may be operated using the order inquiry data. For example, model A, model B and model C may all be provided with the list of products and their results collated, combined, or analyzed.

In another embodiment, the models may be trained in advance and transmitted to the user device 102. An authenticated user may then access the models locally, without submitting an order inquiry to a server device 104. Doing so may have numerous benefits, such as faster and less computationally expensive processing due to the elimination of round-trips via network 106. It should be appreciated that any combination of user devices and servers may be used, including embodiments where no server is used.

Once all models are operated using the product inquiry data and, in some embodiments, customer data, the results may be transmitted to user device 102, where they may be displayed to the user as checkout options. The user may choose one or more checkout options and may submit another request to server device 104, indicating the user's intent to proceed to purchase the items using the economizer method. The server device 104 may receive the user's request and may initiate a withdrawal of an amount corresponding to the amount of the economizer payments from the user's account and/or initiate the deposit of some related amount into an account of the merchant. The withdrawals and deposits may be handled directly by instructions executing in server device 104, or may be abstracted into API calls passed to payments gateway 156 or another source.

In another embodiment, instructions residing in program storage 134 of server device 104 may be run periodically in a batch process. The instructions may train a model in model training module 150, and/or retrieve model(s) from model data 162. The instructions may also query customer data 160 to calculate respective average purchases of one or more customers. For each customer in customer data 160, or selectively, the instructions may analyze the respective average purchases using the trained/retrieved models, to determine required monthly average purchases required to avoid repayment of each user's current balance. Having determined the status of the user's account with respect to period payments, the instructions may then generate notifications for users. The notifications may take any suitable form, including without limitation email, text messages, and/or push messages.

For simplicity, the above examples are described in terms of a single customer and a single merchant. However, it should be readily apparent to those skilled in the art that in some valuable embodiments, a plurality of merchants may offer products to sale to multiple customers, and that the available credit and balances applicable to the respective customers may be shared or “netted” across transactions between the respective customers and the plurality of merchants. For example, a customer may patronize a grocery store, a pharmacy, and a restaurant each having a different respective owner. However, a single available credit of $200 may apply with respect to each of the stores, such that when the consumer makes a purchase at the grocery store, the customer's available balance is reduced accordingly at the pharmacy, and so on.

### III. Example Method of Economizer-Processed Payment

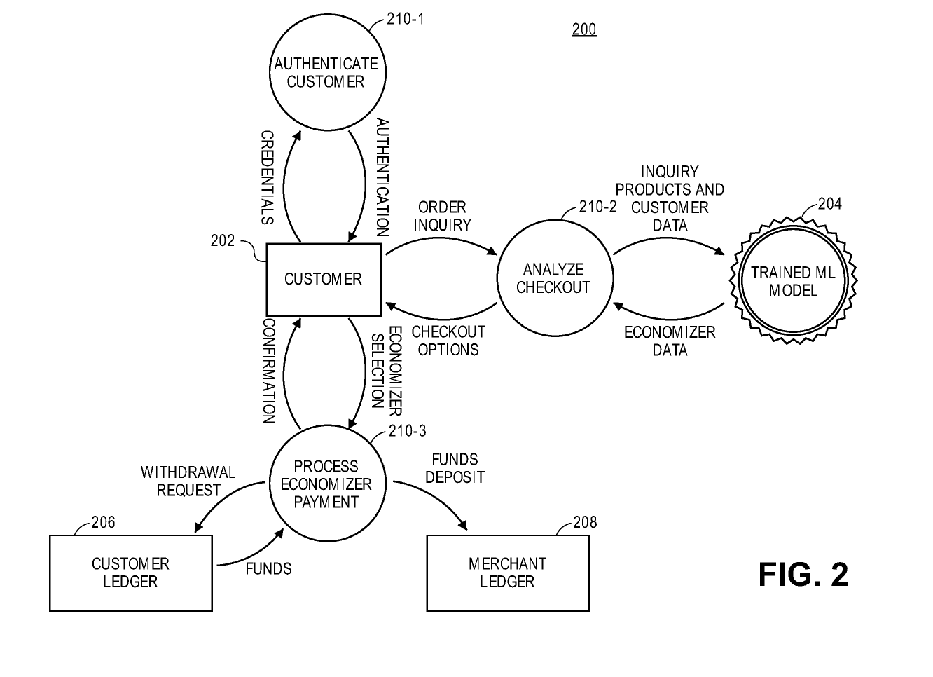

With regard to FIG. 2, a flow diagram 200 for an economizer processed payment and delivery using trained machine learning models to improve profitability and provide liquidity is depicted, according to an embodiment. Diagram 200 may include a customer 202, a trained ML model 204, a customer ledger 206, a merchant ledger 208, and a process nodes 210-1 through 210-3.

Customer 202 may correspond to a person shopping via a network (e.g., the Internet) or visiting a store in person (e.g., a brick-and-mortar store). For example, customer 202 may correspond to the grocery shopper discussed with respect to FIG. 1. Customer 202 may provide credentials, whether in the form of a username/login, secure token, credit card, etc. to a customer authentication process node 210-1. Authentication process node 210-1 may correspond to a module in model training module 150, or may be a service provided by another component (e.g., payments gateway 156). Authentication process node 210-1 may check customer 202 credentials and if the credentials are valid, may authenticate customer 202.

Next, authenticated customer 202 may place an order inquiry with checkout analyzer process node 210-2. Checkout analyzer process node 210-2 may correspond to one or more modules in model training module 150, and/or a trained model (e.g., ML model 118). In some embodiments, checkout analyzer process node 210-2 may correspond to a single processing script in program storage 134 executed by processor 110. An order inquiry may take any form, such as an electronic form. The order inquiry may include an indication of the item(s) or product(s) the consumer intends to purchase. Herein, the product(s) may be known as “products of interest”. For example, a list of universal product codes (UPCs) or other unique identifiers may be provided by customer 202 to checkout analyzer process node 210-2. Such codes may be provided without the customer 202's direct knowledge; in that the codes may be embedded in HTML and/or other code that customer 202 may interact with, but may not explicitly understand or direct. Once checkout analyzer process node 210-2 receives the order inquiry, checkout analyzer process node 210-2 may analyze the order inquiry. For example, checkout analyzer process node 210-2 may extract unique product codes from the inquiry. Checkout analyzer process node 210-2 may, for each product code, determine whether an economizer price has been previously determined by consulting a cache or other store of such information. For example, model data 162 and/or customer data 160 may include a listing of economizer prices with respect to certain products and/or users. Each listing may include an expiration date, and the cache may be considered by checkout analyzer process node 210-2 to contain an entry if and only if the expiration date has not yet passed. In this way, only “fresh” economizer prices may be retrieved from the cache. In some embodiments, a cache is not used. If an economizer price is not available for a given product, then checkout analyzer process node 210-2 may submit a product inquiry and/or customer data to trained ML model 204 to obtain/generate economizer data.

Trained ML model 204 may correspond to any model trained by model training module 150 (e.g., a model produced by spending patterns module 152, or ML model 118). Trained ML model 204 may be a machine learning model, or a model of another type. Trained ML model 204 may receive product inquiry and/or customer data from checkout analyzer process node 210-2, and may be trained to output economizer data. Economizer data may include a ratio or percentage of a list price with respect to a product included in a product inquiry. For example, a product inquiry may include a product identified by UPC, and a list price of $100. In an embodiment, a product inquiry may also include other information about the product, such as a description of the item, its name, etc. In some embodiments, trained ML model 204 may look up information about the product (e.g., via a UPC query) from a products database. Based on the information about the product, the user, other transaction information (e.g., applicable credit card fees), and/or the number of items being purchased, trained ML model 204 may predict an economizer price of $98 due to a 2% discount. The economizer data, including the percentage discount, may be received by checkout analyzer process node 210-2, and may be used to generate checkout options. For example, a checkout screen may be presented in any suitable electronic format, such as via a graphical user interface of customer 202's computing device (e.g., display device 124 of user device 102). The trained ML model 204 may provide economizer data that may be used in further payment processing.

For example, economizer data may include multiple payment options, such as payment by cash, credit card, crypto-currency, or economizer, wherein the economizer price may correspond to the discounted economizer price generated by trained ML model 204. A user may associate one or more virtual wallets (e.g., Bitcoin wallets) or addresses with an account that the user may use to fund economizer purchases. The economizer data may provide checkout analyzer process node 210-2 with the savings of using an economizer payment over another payment method, the user's credit limit, the user's current balance, and a calculated minimum payment required for the user to proceed with the economizer payment. In an embodiment, the discounted economizer price only applies if a consumer selects the economizer method of payment.

Customer 202 may make a selection from amongst checkout options provided by checkout analyzer process node 210-2 (e.g., via a selection using display device 124). If customer 202 selects payment via economizer, then the economizer selection may be transmitted via network 106, for example, to process economizer payment node 210-3, which may be located in a server (e.g. server device 104). However, it should be noted that in some embodiments, all processing nodes 210-1 through 210-3 may be located in a single user device 102. Process economizer payment node 210-3 may transmit a withdrawal request to customer ledger 206, and may receive funds from customer ledger 206. In an embodiment, funds may be unavailable/insufficient, in which case process economizer payment node 210-3 may abort. If funds are successfully received, process economizer payment node 210-3 may deposit funds into merchant ledger 208. Next, process economizer payment node 210-3 may transmit confirmation to customer 202. Confirmation may be in the form of an email or other electronic acknowledgement.

In an embodiment, an order inquiry may be received at server device 104, and may include data relating to a user (e.g., a buyer, renter, shopper/patron, etc.) and/or a first product of interest. The data corresponding to the user and/or the first product of interest may be analyzed by a machine learning model trained on labeled data to generate a credit limit associated with the user, and a discounted price corresponding to the first product of interest, which may be lower than a credit card price corresponding to the first product of interest. Once the discounted price and credit limit are determined, both or either may be transmitted to a device (e.g., a mobile device of the user), and may be displayed to the user (e.g., in display device 124). The user may interact with an input device to make an economizer selection, thus bypassing the credit card payment option, and an indication of the economizer selection may be transmitted to/received by the server device or another device. In response to receiving the economizer selection, funds from a first ledger may be debited (e.g., withdrawn) from the first ledger and/or may be credited (e.g., deposited) to a second ledger. The funds withdrawn and deposited may be respectively fungible, and may be in the same or different amounts. For example, in some embodiments, due to financial system/market/clearing operations, either withdrawal or deposit may delayed or pended for a period of time (e.g., days, hours, or weeks), in full, and/or partially. In some embodiments, withdrawal/deposit may be initiated in the form of a request sent to an external account/ledger gateway. For example, an ACH transfer or other suitable method of funds transfer/withdrawal/deposit may be used. The initiation/request to withdraw/deposit may be asynchronous with respect to the methods and systems described herein, and as noted above, may be sent/received via payment systems APIs which require separate authentication.

Once the discounted price and credit limit are determined, an additional or alternate flow may be executed. For example, in some embodiments, a second product of interest may be identified (e.g., by a machine learning or other algorithm analyzing the first product of interest). The second product of interest may be associated with a second discounted price and/or a second credit limit, and may transmitted to the user as described above along with an offer to substitute the second product of interest for the first product of interest, wherein the second product of interest and the first product of interest are similar products. In an embodiment, two distributors of goods may be allowed to compete for the business of the buyer by submitting bids, in real-time with respect to the shopping buyer, to server device 104. The distributors' respective bids may include a coupon that the buyer may instantly redeem in order to complete the purchase of a product (e.g., the first product of interest). The distributors' bids may also include a payment to the proprietor of server device 104. This competitive bidding scenario may be initiated in response to a sensor and/or application executing in user device 104 detecting the presence of a particular product.

For example, a buyer may be at a consumer electronics store examining laptop computers for purchase. The buyer may pass Laptop A, and user device 102 may detect the make, model, and/or capabilities of Laptop A. The detected information may be transmitted to server 104 at the time the buyer submits an order inquiry, or in response to the detection. Server 104 may receive the detected information and prompt pre-registered competitors of Laptop A (e.g., the distributors of Laptops B and C) to submit instantaneous offers to sell (bids) for Laptops B and C. The bids may both be transmitted to the user as a series of options, or, the “best” bid (e.g., the lowest price, or best combination of price and features) may be transmitted to the buyer, in addition to a description of the first, or “winning”, product of interest, which may be displayed to the user in conjunction with, or separately of, the best bid/coupon. It should be appreciated that in an embodiment, there may be any number of bidders, and that the proprietor of server device 104 may also bid.

In this way, the proprietor of the economizer methods and systems described herein may provide the ability for sellers to dynamically sell products that compete with products of interest to potential buyers, in real-time. Such offers may be generated and offered to buyers via internet commerce, or in a store. The first product of interest may be a physical item that a buyer is holding in a store, for example, and the second product of interest may be a virtual (e.g., online) listing of a product similar to the first product of interest, and vice versa. Similarly, both products may be physical products, or both products may relate to virtual (e.g., ecommerce) items. Regardless of whether the first and second products of interest are physically held by the buyer at the time the offer is made, the user may be apprised of such offers in by a mobile computing device of the user.

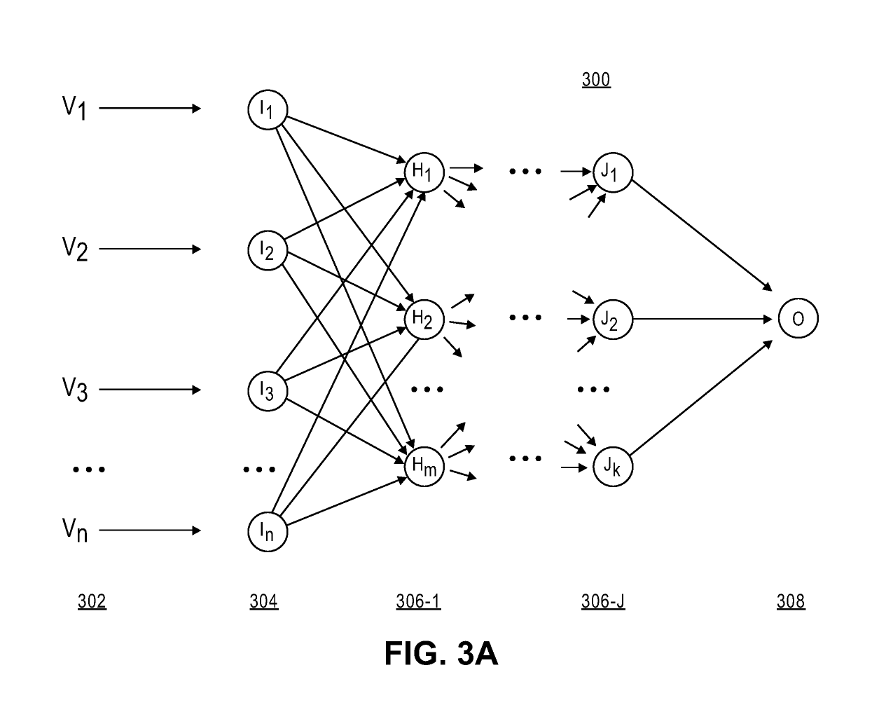

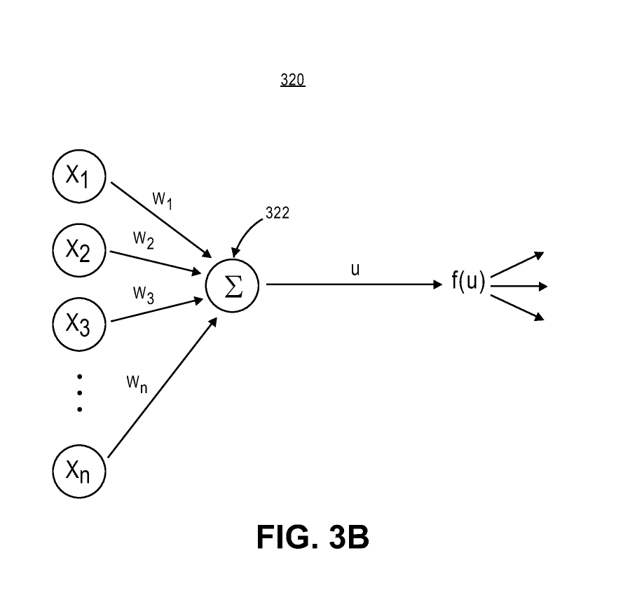

By use of the above-described processing, trained models may instantaneously determine economizer data, including pricing, with respect to purchase inquiries of consumers, based both on the products the consumers are purchasing, and demographic and historical data pertaining to the customers. It should be appreciated that in some cases, the receipt of product inquiry and/or customer data by trained ML model 204 may cause trained ML model 204 to be retrained, either partially or wholly. Such incremental training may ensure that trained ML model 204 is continuously updated and providing the most accurate economizer data. The training of economizer models is discussed in further detail with respect to FIG. 3A and FIG. 3B.

### IV. Example Artificial Neural Network for Economizer Model Training

Turning to FIG. 3A, an example artificial neural network 300 that may be used to generate economizer data is depicted, according to an embodiment. Neural network 300 may correspond to trained ML model 204 and/or ML model 118, for example. Neural network 300 may include a plurality of input values V₁-Vₙ, which may correspond, respectively, to a plurality of input neurons I₁-Iₙ. The plurality of input values 302 and plurality of input layer 304 may be interconnected, and each of the plurality of input values may be independently analyzed prior to being fed to the neural network 300. Neural network 300 may include hidden layers 306-1 through 306-J, wherein J may be any positive integer, and wherein each hidden layer may comprise one or more interconnected neurons. The number of neurons per hidden layer may vary, such that m and k in Hₘ and Hₖ may be any positive integer(s). Neural network 300 may also include an output layer 308. Multiple layers of neural network 300 may correspond to respective models. For example, hidden layers 306-1 through 306-(J-10) may correspond to spending patterns module 152, while hidden layers 306-(J-9) through 306-J may correspond to future profits module 154. As discussed with respect to FIG. 1, model training module 150 may combine, or “stack” one or more sets of layers at the time server device 104 executes training instructions stored in program storage 134, and the resulting model may then be transmitted to another device for use as a single unit (e.g., to user device 102 as ML model 118).

As depicted, a textual input (e.g., a product UPC) V₁ may be passed to input layer 304. Input layer 304 may receive additional information pertaining to a product, a user, or another fact (e.g., the time of day). For example, V₂ may correspond to the current balance of a user, and V₂ may correspond to the user's credit limit. Input layer 304 may identify that the product corresponds to a particular category of products (e.g., electronics), and may transform the textual input into a feature. A feature may be an integer or other numeric value that, in isolation, is insufficient to allow a human to determine meaning but which when input into subsequent layers 306-1 through 306-J allows the layers to generate an accurate prediction utilizing consumer data 160 (e.g., consumer characteristics) and/or historical spending patterns, as discussed above. Each model comprising multiple layers may be weighted, so that the value(s) output by output layer 308 represent a consensus among the multiple models with respect to the accuracy of the prediction of future consumer profits to the seller. Models may be added and subtracted according to the needs of particular embodiments.

With respect to FIG. 3B, an example neuron 320 is depicted. Neuron 320 may correspond to neuron H₁ of hidden layer 306-1 in FIG. 3A, according to an embodiment. Neuron 320 may accept inputs X₁ through Xₙ, which may correspond to input neurons I₁-Iₙ of FIG. 3A, and may include weights W₁ through Wₙ. Weights may be determined during the training process, and may be initialized to random values at the outset of training, and appropriate weights for determining accurate predictions discovered via the training process. Weights may be stored in model data 162 or in another suitable location (e.g., data storage 136). Weights may be applied to a summation node 322 of neuron 320. In some cases, one or more weights may be ignored by neuron 320. The sum of the weighted inputs may be calculated as u, and may be passed to a function f, which may apply any suitable linear or non-linear operation to u. The output of the function f may be provided to any number of subsequent layers, as depicted. For example, the output of the function f may indicate a purchase category, a future monthly average purchase, a likely future upper limit, or an indication of an exceeded balance, and/or a discount as a ratio/percentage of a list price. In other embodiments, and training scenarios, neuron 320 may be arranged differently. For example, a function other than summation may be used, or weights may be adjusted according to an external process.

### V. Example Method for Training Economizer Machine Learning Model to Process Payments

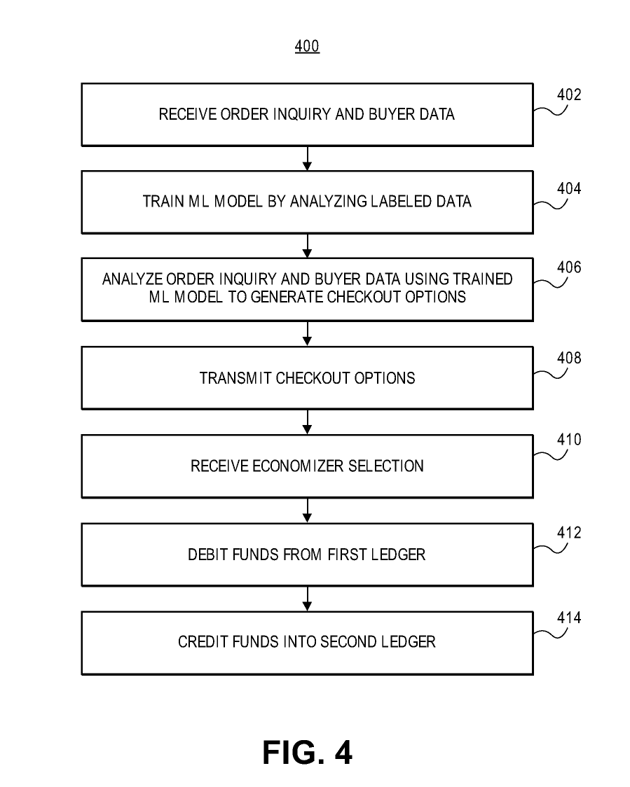

With respect to FIG. 4, an example method 400 of using economizer methods to provide liquidity and process payments via training a machine learning model is depicted. The method 400 may include receiving an order inquiry and/or buyer data (block 402). Buyer data may be equivalently referred to, herein, as customer data or consumer data. As discussed with respect to FIG. 2, an order inquiry may include information about the product(s) the customer wants to buy, as well as pricing information, and/or information about the customer. The method 400 may include training a machine learning model by analyzing labeled data (block 404). In some cases, labeled data used for training may be selected at runtime based on the product(s) being purchased, purchase history of the customer, demographic information of the customer, or other factual data accessible to the methods and systems described herein (e.g., the time of day, a photograph, etc.). Training the artificial neural network may be performed by one or more servers, while the buyer waits, or in advance. For example, an array of CPUs may be used to accelerate training performed by model training module 150. In this way, a consumer may have a very short wait (e.g., 10 ms) before a model is trained and ready to be operated.

In general, training a ML model may include establishing a network architecture, or topology, as described with respect to FIG. 3; adding layers including activation functions (e.g., a rectified linear unit, softmax, etc.), loss function, and optimizer. In an embodiment, a different neural network type may be chosen (e.g., a recurrent neural network, convolutional neural network, deep learning neural network, etc.). Training data may be divided into training, validation, and testing data. Data input to the neural network may be encoded in an N-dimensional tensor, array, matrix, or other suitable data structure. In some embodiments, training may be performed by successive evaluation (e.g., looping) of the network, using training labeled training samples. The process of training the artificial neural network may cause weights, or parameters, of the artificial neural network to be created. The weights may be initialized to random values. The weights may be adjusted as the network is successively trained, by using one of several gradient descent algorithms, to reduce loss and to cause the values output by the network to converge to expected, or “learned”, values. In an embodiment, a regression neural network may be selected to predict pricing values which has no activation function. Therein, input data may be normalized by mean centering, and a mean squared error loss function may be used, in addition to mean absolute error, to determine the appropriate loss as well as to quantify the accuracy of the outputs. ML models may be subject to validation and cross-validation using standard techniques (e.g., by hold-out, K-fold, etc.). The labeled data used to train the neural network may include respective data corresponding to a large group of users and/or products of interest. In some embodiments, multiple neural networks may be separately trained and operated.

The method 400 may further include analyzing the order inquiry information and/or buyer data using the trained ML model to generate checkout options (block 406). As discussed with respect to FIG. 2, the checkout options may include multiple forms of payment (e.g., credit cards, cash, etc.) and may list the options comparatively so that consumers may make an intelligent decision with respect to the potential savings. In particular, a consumer may avoid using a credit card where to do so may incur transaction fees paid to an intermediary. The method 400 may include transmitting the checkout options to a user (block 408). The transmission may be made from a user device to a user device (e.g., user device 102 to user device 102) or from a server (e.g., server device 104) to a client device. The checkout options may be transmitted as an invoice, an electronic form, an email, and/or in any other suitable format. The method 400 may include receiving an economizer selection (block 410). The selection may be generated by a user action, such as an electronic form submission or hyperlink activation in response to a mouse click or other hardware-generated event (e.g., via input device 126). Based on the receipt of an economizer selection, the method 400 may include debiting funds from a first ledger (e.g., a ledger or account of a customer, a bank, a corporation, or another legal entity) or equivalent source of funds (block 412) and a corresponding crediting of funds to a second ledger (e.g., a ledger or account of a customer, a bank, a corporation, or another legal entity) or equivalent source of funds (block 414). In an embodiment, one or both of the debiting and crediting of funds may, respectively, involve a crypto-currency transaction (e.g., a Bitcoin transaction) and/or the addition of information to a block chain. In some embodiments, an acknowledgement may be generated and/or transmitted upon successful conclusion of the method 400. In some cases, debiting and/or crediting may include making suitable entries corresponding to immediate crediting/debiting, such as transaction records or transaction logs that may be executed/reconciled at a later time.

### VI. Example Method for Training Economizer Machine Learning Model to Maintain Liquidity

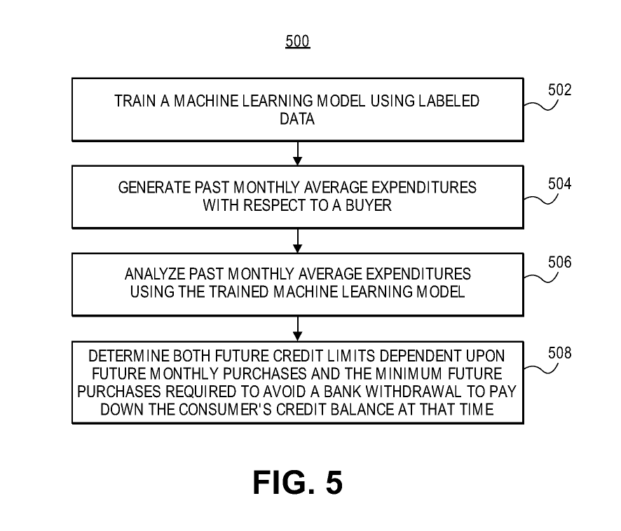

Turning to FIG. 5, an example method 500 for training an economizer machine learning model to maintain liquidity with respect to existing customer accounts is depicted. The method 500 may include training a machine learning model using labeled data (block 502). The machine learning model may correspond to a model in model training module 150, which may not be depicted. The labeled data may be, for example, a data set of historical customer purchases, of a single buyer or a cohort of buyers, and the data may be sourced from customer data 160 or another source. The machine learning model may be trained to predict a likely future monthly expenditure based on the historical purchase data. The method 500 may also include generating past monthly average expenditures with respect to a buyer over an interval of time (block 504). The buyer may, for example, correspond to a user of user device 102. The method 500 may further include analyzing the past monthly average expenditures of the buyer using the trained machine learning model (block 506). For example, average monthly purchases of one or more buyer with respect to one or more month may be computed. The method may include determining future credit limits and future trailing average purchases based on future monthly purchases required to avoid a bank withdrawal to pay down the consumer's credit balance at the time (block 508). For example, a forecasted trailing average purchases may be calculated, in addition to a forecasted credit limit, with respect to one or more future month. Future profits may be optimized by training an artificial neural network to optimize an economizer credit limit and product price with respect to a user by, for example, extending credit where doing so is likely to result in a purchase by a consumer who will likely repay the credit, and by setting prices to optimize sales/profit. For example, the neural network may include one input corresponding to the creditworthiness of the consumer, and other variables. The likelihood that a consumer will repay credit may be determined using historical repayment data.

Optimum sales/profit may be determined by training a neural network according to one or more profit maximization strategy. For example, a neural network may be trained that seeks to bundle the sale of certain items, or which adds markup based on time values. Any such suitable strategies and related data sets may be used. Additionally, or alternatively, the “purchasing power” of a consumer may be forecasted to match the customer's future credit limit so that not only will the amount of credit extended to the customer enable the customer to purchase one or more products, but also, the purchases will be at the highest price the customer is willing to pay. Past purchases, in terms of products purchased as well as amounts spent, may be analyzed to determine optimum credit and pricing. The method 500 may generally permit a merchant to determine the minimum amount of money a consumer must spend with the merchant to prevent the balance owed from being withdrawn from the consumer's account.

### VII. Example Economizer Checkout User Interface

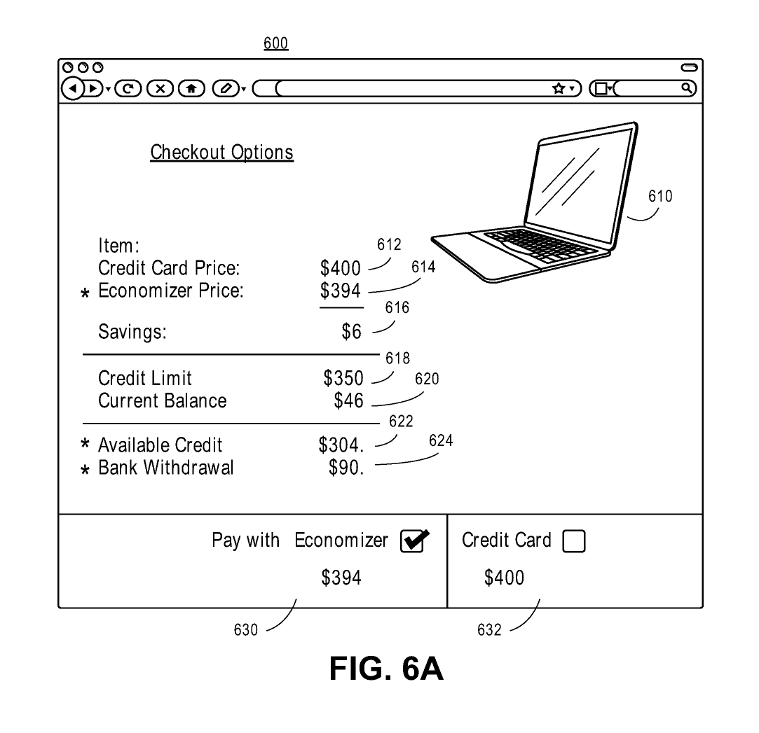

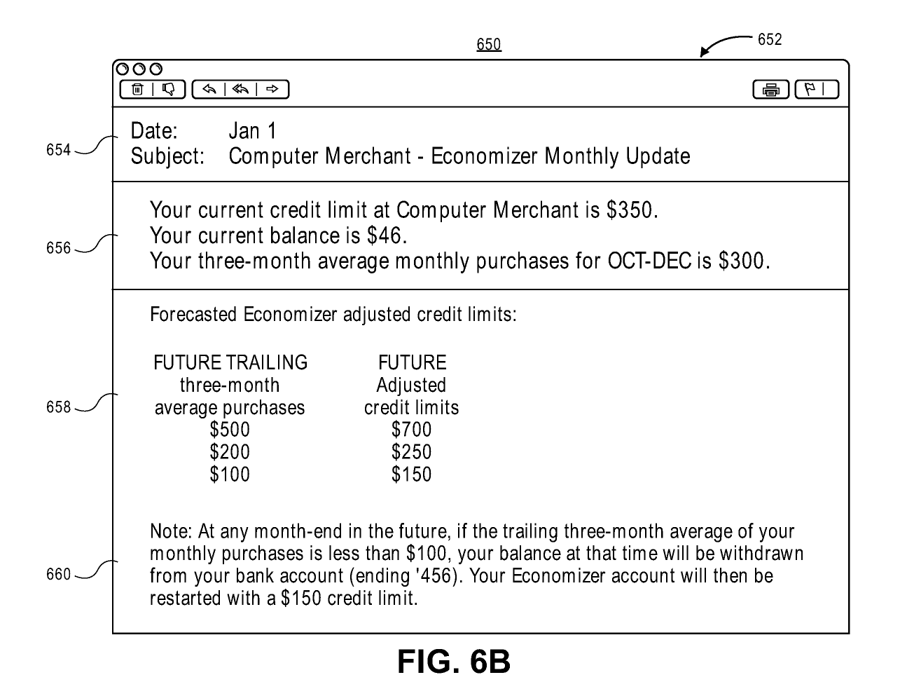

Turning to FIG. 6A, an exemplary user interface 600 for presenting, processing, and displaying checkout options is depicted, according to one embodiment and scenario. User interface 600 illustrates the relevant information presented to customers that enables them to decide whether to use the economizer payment, or another method (e.g., a credit card), and depicts a checkout screen which operates in tandem with the economizer methods and systems discussed above. It should be noted that user interface 600 may be used by a consumer in a physical, or “brick and mortar” store, or by a consumer shopping online. Specifically, as discussed above with respect to FIG. 2, a checkout analyzer process node may receive a wealth of economizer data from a trained artificial neural network or other model. Thus, the user interface 600 may include an item 610, credit card price 612, economizer price 614, savings 616, credit limit 618, current balance 620, an available credit 622, a bank withdrawal 624, an economizer payment option 630, and a credit card payment option 632.

Item 610 may correspond to a product included in an order inquiry transmitted to checkout analyzer process node 210-2 by the user, as discussed above with respect to FIG. 2. A credit card price for the item may similarly be included in an order inquiry, or looked up based on a UPC code or other identification technique with respect to item 610. Economizer price 614 may be based on a discount ratio computed by a trained machine learning model, as discussed with respect to FIG. 2. The economizer price 614 may be calculated by multiplying list credit card price 612 by the discount ratio. In some embodiments, another multiplicand may be used (e.g., the list price in a foreign currency). Savings 616 may be the difference between the credit card price 612 and economizer price 614. Credit limit 618 may be a credit limit associated with a particular customer (i.e., the maximum balance that the customer can owe a merchant), and may be based on a default credit limit. Credit limits may be calculated and used in a variety of ways. In some embodiments, available credit 622 is defined as credit limit 618 less current balance 620, and bank withdrawal 624 is defined as economizer price 614 less available credit 622. In an embodiment, bank withdrawal 624 may correspond to customer ledger 206 of FIG. 2.

In an embodiment, a neural network may be trained which—periodically or in response to a purchase inquiry—analyzes consumer credit information, creditworthiness, consumer spending patterns (e.g., purchases by a consumer at a given store), etc. to calculate credit limit 618. In addition, customers' information in customer data 160 may be analyzed by a trained neural network (or another model) which may set economizer prices for products to optimize the expected value of future store profits from individual customers. For example, a model constructed which analyzes historical customer data from all customers of one or more merchant. Information about a given customer and a given product may be input to the model, and the model may set a credit limit and economizer price that is aligned with optimizing the future profits to the seller from the consumer, by determining forecasts of future purchases (e.g., a list of products a consumer is likely to purchase, and the respective prices paid for the products).

User interface 600 may also include the current balance 620 of the user, which may reflect the amount the user owes on the account (e.g., the amount of the total credit limit 618 that the user has spent), and may include two or more payment options in addition to economizer payment option 630 and credit card payment option 632.

Economizer payment option 630 may be the economizer price as computed by an economizer machine learning payment analysis. Available credit 622 may be calculated by subtracting the current balance 620 from the user's total credit limit 618. Bank withdrawal 624 may be the amount that the economizer price 614 exceeds the available credit 622. In the depicted example, bank withdrawal 624 of $90 may be calculated by the following formula: $394 (economizer price)−$304 (available credit)=$90 (bank withdrawal). Consumers may evaluate as a package offer the economizer price 614 of $394, the savings 616 of $6, and the bank withdrawal 624 of $90. This package compares to the credit card payment option 632 of $400, which may be coupled to very large interest payments on unpaid credit card balances. A visual display to customers laying out the economic benefits of avoiding credit card usage (e.g., lower product prices and the avoidance of high interest payments demanded by credit card companies) may provide a strong incentive to prefer economizer checkout/payments. The second payment option may indicate a credit card or other payment method, and if a consumer chooses the second option, a checkout may be performed according to the second payment option.

It should be appreciated that the above depicts a simple example involving a single product being purchased from a single merchant, and a binary decision between an economizer payment and another payment method. However, those of skill in the art will recognize that some embodiments may involve multiple products, multiple merchants, and hybrid payments (e.g., a partial economizer payment, and a partial credit card or other payment).

### VIII. Example Economizer Periodic Update User Interface

With regard to FIG. 6B, an exemplary user interface 650 for analyzing, presenting, and displaying a periodic update of a merchant economizer account is depicted, according to one embodiment and scenario. Generally, user interface 650 may inform customers of their credit limit(s), current balance owed, past monthly average purchases, and required future monthly average purchases corresponding to various forecasted average purchases and credit limits, wherein the forecasted information is determined based on analysis performed by one or more model. Generally, customers are prompted that lower future purchases may result in a reduction of credit limits and/or may require paying down the balance owed. In this manner, a merchant's profits benefit from customers being incentivized to continue to make significant monthly purchases. User interface 650 may be viewed by a consumer in a physical store or a consumer shopping in a virtual (e.g., Internet) storefront. In an embodiment, user interface 650 may be displayed to a user based upon the occurrence of an event (e.g., when a user authenticates, and/or completes a purchase).

User interface 650 may include a graphical user display window 652, headers 654, account summary 656, predicted information 658, and action item 660. Headers 654 may include information relating to an email or other communication method (e.g., text message, application push message, etc.). Account summary 656 may include a prose summary of a user's account with respect to one or more merchants. For example, in the depicted example, spending account summary 656 includes several sentences describing the status of the user's account, including the user's credit limit and current balance, which may respectively correspond to credit limit 618 and current balance 620 of FIG. 6A. Account summary 656 may also include an historical trailing three-month average purchases, which may be calculated with respect to the user's account on demand or by a batch process (e.g., hourly). Although a three-month period is depicted in account summary 656, any time period may be selected. Also, although the information in account summary 656 is presented in prose format, in some embodiments, other display formatting may be used (e.g., tabular formats).

Predicted information 658 includes a table wherein the columns respectively denote a trailing three-month average purchases in the future and forecasted adjusted credit limits to therefore be applied to the consumer's account. It should be noted that the table represents forecasted information, and that at a future date, the forecasted information may differ based on additional inputs to the trained model with respect to the consumer's then-current three-month average monthly purchases, current balance, etc., and/or variables affecting the transaction (e.g., available inventory, the type of items likely to be purchased, spending patterns, etc.). In some embodiments, multiple tables may be used to denote multiple merchants. Future predicted purchase and credit limit information may be obtained by a trained ML model, such as the model trained in block 502 of FIG. 5. Such a model may be stored in model data 162 after it is trained, and may accept data corresponding to the user which is obtained from customer data 160.

Action item 660 may include an indication of the user's current balance, which may correspond to current balance 620 of FIG. 6A, and an indication of the last several digits of the user's bank account. The user may have previously associated a bank account with customer data 160, via instructions contained within an application (e.g., an application residing in program storage 114). Action item 660 specifies a minimum trailing three-month average purchases below which the then-current credit balance will be paid down (e.g., automatically withdrawn from the consumer's bank account). Such a withdrawal may be performed by a batch process (e.g., by instructions in program storage 134 being executed by CPU 130). The withdrawal may be performed by the instructions querying payments gateway 156, in an embodiment, using the user's banking information obtained from customer data 160.er

### ADDITIONAL CONSIDERATIONS

It should be appreciated that the terms “ledger” and “account” may be used for similar or identical purposes herein. While some of the examples herein may refer specifically to payment processing, it should be appreciated that the techniques described herein may be applicable to any domain in which techniques for training neural networks to maintain liquidity and process payments are applicable (e.g., in real estate transactions). It is understood that the term “prediction,” as used herein, may refer to estimation of a future event/state/value/etc., or may refer to estimation of a current (or even a past) event/state/value/etc., depending upon the embodiment and/or scenario. Similarly, the terms “consumer”, “customer”, “user”, and “buyer” may be used interchangeably; as may the terms “seller”, “merchant”, “distributor”, and “manufacturer”. Furthermore, the methods and systems described herein are generally applicable to any transaction in which two parties exchange items of value. Therefore, two merchants may use the methods and systems, or two consumers, to transact business.

Throughout, models may be described as “neural networks” or “ML models”. Those of skill in the art will recognize that the decision of which particular model(s) and/or algorithm(s) to use in any particular embodiment may vary, depending on the objectives of the particular embodiment. With the foregoing, any users whose data is being collected and/or utilized may first opt-in to a rewards, discount, or other type of program. After the user provides their affirmative consent, data may be collected from the user's device (e.g., mobile device, smart vehicle controller, or other smart devices). Of course, deployment and use of neural network models at a user device (e.g., trained ML model 118 of FIG. 1) may obviate any concerns of privacy or anonymity, by removing the need to send any personal or private data to a remote server (e.g., the server device 104 of FIG. 1). In such instances, there may be no need for affirmative consent to be collected.

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning. Unless a claim element is defined by reciting the word “means” and a function without the recital of any structure, it is not intended that the scope of any claim element be interpreted based upon the application of 35 U.S.C. § 112(f). The systems and methods described herein are directed to an improvement to computer functionality, and improve the functioning of conventional computers.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more modules of a computer system (e.g., a processor or a group of processors) may be configured by software (e.g., an application or application portion) as a module that operates to perform certain operations as described herein.

In various embodiments, a module may be implemented mechanically or electronically. Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules are temporarily configured (e.g., programmed), each of the modules need not be configured or instantiated at any one instance in time. For example, where the modules comprise a general-purpose processor configured using software, the general-purpose processor may be configured as respective different modules at different times. Software may accordingly configure a processor, for example, to constitute a particular module at one instance of time and to constitute a different module at a different instance of time.

Modules can provide information to, and receive information from, other modules. Accordingly, the described modules may be regarded as being communicatively coupled. Where multiple of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information. Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment. In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

This detailed description is to be construed as exemplary only and does not describe every possible embodiment, as describing every possible embodiment would be impractical, if not impossible. One could implement numerous alternate embodiments, using either current technology or technology developed after the filing date of this application. Upon reading this disclosure, those of skill in the art will appreciate still additional alternative structural and functional designs for the methods and systems described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein. It is therefore intended that the foregoing detailed description be regarded as illustrative rather than limiting, and that it be understood that it is the following claims, including all equivalents, that are intended to define the spirit and scope of this invention.

1. A computer-implemented method of improving the profitability of a sale, the method comprising:
receiving an order inquiry and user data at a server device, wherein the order inquiry includes at least one product of interest,
training, by the server device, a machine learning model by analyzing labeled data,
analyzing the order inquiry and user data using the trained machine learning model to generate checkout options including at least an economizer price with respect to the product of interest and a credit card price with respect to the product of interest,
transmitting the checkout options to a user device,
receiving, via an input device of the user device, an economizer selection, the economizer selection including at least one determinate price with respect to the at least one product of interest; and
in response to the economizer selection, one or both of (i) initiating a withdrawal of funds from a first ledger, and (ii) initiating a deposit of funds into a second ledger.

2. The computer-implemented method of claim 1, wherein analyzing the order inquiry and user data using the trained machine learning model to generate checkout options includes optimizing future seller profits from consumers.

3. The computer-implemented method of claim 1, wherein optimizing future seller profits from consumers includes one or both of (i) setting a discounted price corresponding to the at least one product of interest which is lower than a credit card price and (ii) setting a credit limit applicable to a payment method operated by the seller which avoids credit card usage.

4. The computer-implemented method of claim 3, wherein the at least one product of interest is a first product of interest, and analyzing the order inquiry and user data using the trained machine learning model to generate checkout options includes determining a second product of interest and a second discounted price corresponding to the second product of interest, and wherein a distributor of the first product of interest outbids a distributor of the second product of interest for the opportunity to display one or both of (i) the discounted price corresponding to the first product of interest, and (ii) a representation of the first product to the user.

5. The computer-implemented method of claim 1, wherein the user device is integral to a point-of-sale cashiering system in a physical store.

6. The computer-implemented method of claim 1, wherein the user device is a mobile computing device of the user.

7. The computer-implemented method of claim 1, further comprising:
displaying, in the user device, a checkout screen including the credit card price and the economizer price.

8. The computer-implemented method of claim 1, wherein the machine learning model comprises an artificial neural network.

9. The computer-implemented method of claim 1, wherein the server device is the user device.

10. The computer-implemented method of claim 1, wherein analyzing the order inquiry and user data using the trained machine learning model to generate checkout options includes one or more of (i) analyzing the credit score of the user, (ii) analyzing the account balance of the user, or (iii) analyzing the frequency with which the user purchases items from a store associated with the at least one product of interest.

11. The computer-implemented method of claim 1, wherein one or both of (i) the first ledger corresponds to a cryptocurrency address and (ii) the second ledger corresponds to a cryptocurrency address.

12. The computer-implemented method of claim 1, wherein one or both of (i) a merchant is a legal owner of the first ledger, and (ii) a merchant is a legal owner of the second ledger.

13. The computer-implemented method of claim 1, wherein the economizer selection includes a partial credit card selection, and further comprising:
calculating a pro-rata credit card payment amount,
in response to the partial credit card selection, one or both of (i) transmitting a withdrawal request to a credit card account, the funds from the credit card account corresponding to the pro-rata credit card payment amount; and
transmitting a request to credit at least some of the funds from the credit card account into the second ledger.

14. A computer-implemented method of improving liquidity, the method comprising:
training, in a server device, a machine learning model by analyzing one or more of (i) consumer characteristics, (ii) past spending patterns, or (iii) the composition of products being purchased, each with respect to a user,
forecasting, using the trained machine learning model, future purchases of the user; and
determining, using at least the forecasted future purchases of the user, one or both of (i) a credit card price with respect to a product and an economizer price with respect to the product, and (ii) an economizer credit limit, to optimize profit from the user.

15. The computer-implemented method of claim 14, further comprising:
displaying an update screen including the credit card price and the economizer price.

16. A consumer-implemented method of facilitating a consumer checkout in a store within a graphical user interface, the method comprising:
transmitting, to a server device via a computer network, a request including an indication of at least one product of interest,
analyzing, using a trained neural network, at least the indication of at least one product of interest to identify an economizer price and an economizer credit limit,
transmitting the economizer price, a credit card price, and the economizer credit limit, to the user device via a user device; and
displaying, in the graphical user interface, the economizer price, the economizer credit limit, and the credit card price.

17. The computer-implemented method of claim 16, further comprising:
displaying a periodic update screen including a credit card price and an economizer price.

18. A computer system comprising:
one or more processors; and
one or more memories storing instructions which, when executed by the one or more processors, cause the computing system to:
receive an order inquiry and data of the user at a server device, wherein the order inquiry includes at least one product of interest,
train, in the server device, a machine learning model by analyzing labeled data,
analyze the data of the user and at least one product of interest using the trained machine learning model to generate one or both of (i) a discounted price corresponding to the product of interest, wherein the discounted price is lower than a credit card price corresponding to the product of interest, and (ii) a credit limit associated with the user,
transmit the one or both of the discounted price, and the credit limit to a user device,
receive, via an input device of the user device, an economizer selection, wherein the economizer selection circumvents credit card usage; and
in response to the economizer selection, one or both of (i) initiate a withdrawal of funds from a first ledger, and (ii) initiate a deposit of funds into a second ledger.

19. The computing system of claim 18, wherein the user device is integral to a point-of-sale cashiering system in a physical store.

20. The computing system of claim 18, wherein the user device is a mobile computing device of the user.

21. The computing system of claim 18, wherein the instructions cause the computing system to analyze one or more of (i) the credit score of the user, (ii) the account balance of the user, or (iii) the frequency with which the user purchases items from a store associated with the at least one product of interest.

22. The computing system of claim 18, wherein at least one product of interest is a first product of interest, and the instructions further cause the computing system to determine a second product of interest and a second discounted price corresponding to the second product of interest, and wherein a distributor of the first product of interest outbids a distributor of the second product of interest for the opportunity to display one or both of (i) the discounted price corresponding to the first product of interest, and (ii) a representation of the first product to the user.
